(19) United States
(12) Patent Application Publication
(10) Pub. No.: US 2010/0290431 A1
(43) Pub. Date: Nov. 18, 2010

(54) METHOD AND SYSTEM FOR FAST HANDOVER BETWEEN DIFFERENT NETWORKS

(75) Inventors: Mi-Jeong Yang, Daejeon-city (KR); Kyung-Yul Cheon, Daejeon-city (KR); Ae-Soon Park, Daejeon-city (KR)

Correspondence Address: LAHIVE & COCKFIELD, LLP;FLOOR 30, SUITE 3000, ONE POST OFFICE SQUARE, BOSTON, MA, 02109, US

(73) Assignees: KT CORPORATION, Seongnam-city (KR); ELECTRONICS AND TELECOMMUNICATIONS RESEARCH INSTITUTE, DAEJEON-CITY (KR)

(21) Appl. No.: 12/809,291

(22) PCT Filed: Jul. 21, 2008
(86) PCT No.: PCT/KR08/04240

§ 371 Date: Jun. 18, 2010

(30) Foreign Application Priority Data
Dec. 18, 2007 (KR) 10-2007-0133737

(51) Int. Cl. H04W 36/16

(52) U.S. Cl. 370/331

(57) ABSTRACT

A method for fast handover between a 3GE network and a WLAN is provided. When a network change event that represents that a received WLAN signal can disappear or be captured is generated based on the WLAN signal, a terminal receives information on a new access router (NAR) to be used after handover from a previous access router (PAR) to which the terminal is currently connected using a network identifier, and all packets transmitted from the terminal to the PAR are buffered in the NAR. The NAR transmits all the buffered packets to the terminal when receiving a fast neighbor advertisement (FNA) message from the terminal to perform fast lossless handover.

### TECHNICAL FIELD

This application claims the benefit of Korean Patent Application No. 10-2007-0133737, filed on Dec. 18, 2007, in the Korean Intellectual Property Office, the disclosure of which is incorporated herein in its entirety by reference.

The present invention relates to a method and a system for fast handover between different networks.

The present invention is derived from the research performed as a part of the IT new growth power core technology development project of Ministry of Information and communication of Korea [Project management number: 2005-S-404-33, Project name: 3G Evolution terminal technology development].

### BACKGROUND ART

Mobile communication services are rapidly changed from circuit based voice services to various IP based packet services. However, current 3G mobile communication systems have a transmission rate and capacity insufficient for effectively supporting high-speed multimedia packet services. To solve this, 3GPP (3^{rd} Generation Partnership Project) makes researches in 3GPP System Architecture Evolution/Long Term Evolution: 3G Evolution (referred to as 3GE hereinafter)).

### DISCLOSURE OF INVENTION

### Technical Problem

Meanwhile, operation relationship between wireless networks becomes important as various means capable of connecting to a public network by radio are provided. In particular, a wireless local area network (WLAN) is rapidly spread because it is inexpensive and convenient and is easily applied to a hot spot area.

Although the 3GE system is developed for ultrahigh-speed transmission, the 3GE system is required to cooperatively operate with a WLAN in terms of price and hot spot accessibility because the 3GE system is an expensive commercial operator network.

### Technical Solution

Furthermore, IPv6 technique which makes up for the weak points of IPv4 is a basic IP technique in a next generation network and requires IPv6-based mobile IPv6. However, the mobile IPv6 (MIPv6) produces handover latency according to an IP address change and packet loss while the MIPv6 provides improved functions over the existing mobile IPv4. To improve this, IETF proposes fast mobile IPv6 (FMIPv6) which is considered as a solution most suitable to provide IPv6 mobility.

FMIPv6 predicts terminal mobility based a link layer(L2), and thus a method of providing an event from the second layer and a method of cooperatively operating FMIPv6 with MIPv6 for registering a mobile terminal with a home agent are required. Furthermore, in case of handover between different networks, a procedure of connection signaling of each network is needed.

### Advantageous Effects

the present invention provides a lossless cooperative operation structure between different networks having complementary characteristics to achieve high mobility at a low cost. Moreover, a 3GE mobile common carrier can economically disperse data concentration in a hot spot area and a WLAN carrier can secure a larger number of subscribers, and thus users can be provided with high mobility and fast data transmission at a low cost.

### DESCRIPTION OF DRAWINGS

The above and other features and advantages of the present invention will become more apparent by describing in detail exemplary embodiments thereof with reference to the attached drawings in which:

FIG. 1 illustrates a network structure having a 3GE network and a WLAN to which the present invention is applied;

FIG. 2 illustrates a configuration of a dual mode terminal including a 3GE interface and a WLAN interface to which the present invention is applied;

FIGS. 3A and 3B illustrate a process for handover from a WLAN to a 3GE network according to an embodiment of the present invention;

FIG. 4 illustrates a process for handover from a 3GE network to a WLAN according to an embodiment of the present invention; and

FIG. 5 illustrates a handover operation in a system for supporting fast handover between a 3GE network and a WLAN according to an embodiment of the present invention.

### BEST MODE

The present invention provides a method for fast lossless handover between a 3GE network and a WLAN in a 3GPP SAE/LTE system.

An L2 module generates a link going down event based on signal intensity of the

WLAN. Here, tracking area identification (TA-ID) of the 3GE network or access point identification (AP-ID) of the WLAN is used as a connection node identifier of a network to which a mobile terminal newly moves. A preparatory operation for handover is performed before the mobile terminal moves to the new network, and buffering is carried out in order to prevent packet loss until the mobile terminal moves to the new network. Then, the mobile terminal is connected to the 3GE network or the WLAN when the terminal moves to the new network and registered with a home network, and then handover is finished.

The present invention provides fast lossless handover while maintaining the advantages of the 3GE mobile communication network and the WLAN. Specifically, the WLAN is inexpensive, guarantees high-speed data transmission and facilitates system development and the 3GE mobile communication system can provide high mobility because it has a wide service area.

Furthermore, the present invention provides a lossless cooperative operation structure between different networks having complementary characteristics to achieve high mobility at a low cost. Moreover, a 3GE mobile common carrier can economically disperse data concentration in a hot spot area and a WLAN carrier can secure a larger number of subscribers, and thus users can be provided with high mobility and fast data transmission at a low cost.

According to an aspect of the present invention, there is provided a method for fast handover between a 3GE network and a WLAN, the method including generating a network change event that represents the state of a WLAN signal based on the intensity of the WLAN signal, preparing a handover by allowing a terminal to receive information on a second router of a new network to be used after handover from a first router to which the terminal is currently connected using a network identifier when the network change event is generated, buffering all packets transmitted from a destination terminal corresponding to the terminal to the first router in the second router on the basis of the information on the second router, and handovering the buffered packets to the terminal when the second router receives a fast neighbor advertisement (FNA) message from the terminal.

According to another aspect of the present invention, there is provided a system for fast handover between a 3GE network and a WLAN, the system including a triggering unit generating a network change event that represents the state of a WLAN signal received by a terminal based on the intensity of the WLAN signal, a handover preparation unit allowing the terminal to receive information on a second router of a new network to be used after handover from a first router to which the terminal is currently connected using a network identifier when the network change event is generated, a buffering unit buffering all packets transmitted from a destination terminal corresponding to the terminal to the first router in the second router on the basis of the information on the second router, and a handover unit transmitting the buffered packets to the terminal when the second router receives an FNA message from the terminal.

### Mode for Invention

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those of ordinary skill in the art. Throughout the drawings, like reference numerals refer to like elements.

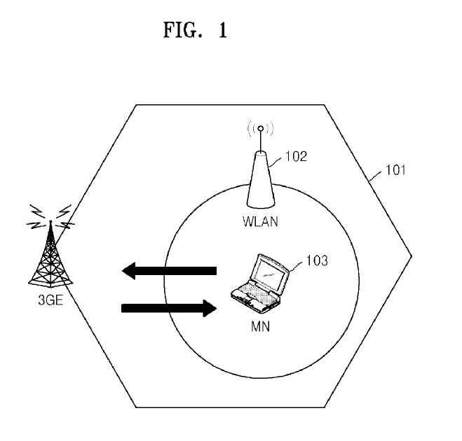

FIG. 1 illustrates a network structure having a 3GE network 101 and a WLAN 102 to which the present invention is applied. The 3GE network 101 provides a wide service area and the WLAN 102 forms an overlay network structure providing wireless connection in a hot spot area such as a building, a station, an airport and so on.

The WLAN is inexpensive, guarantees fast data transmission and facilitates system development so that the WLAN has excellent accessibility in hot spot areas such as airports and subway stations. However, the WALN cannot provide sufficient mobility because it has a small service area. The 3GE network provides high mobility because it has a wide service area. However, the 3GE network is expensive and requires a high cost to develop a system and construct a network.

Accordingly, the present invention provides a lossless cooperative operation structure between different networks having complementary characteristics to achieve high mobility at a low cost. Accordingly, a 3GE mobile common carrier can economically disperse data concentration in a hot spot area and a WLAN carrier can secure a larger number of subscribers, and thus users can be provided with high mobility and fast data transmission at a low cost.

The present invention proposes a structure and a process for fast lossless handover between the 3GE network and the WLAN in the aforementioned overlay network structure.

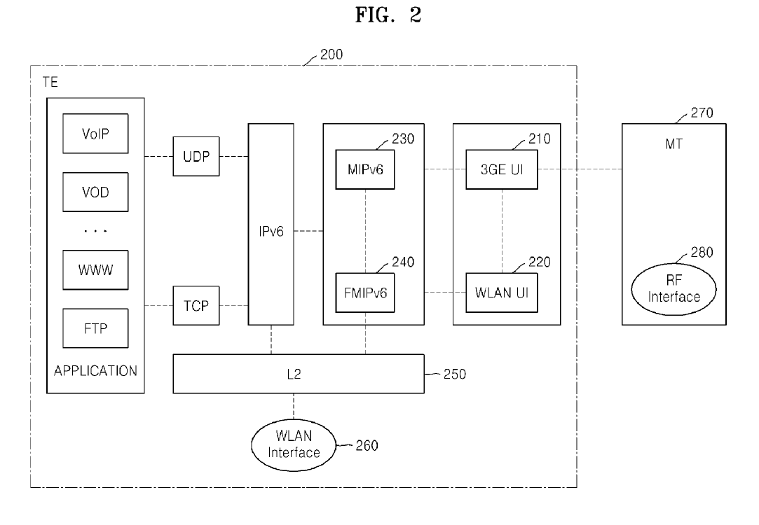

FIG. 2 illustrates a dual mode terminal 200 including a 3GE interface and a WLAN interface to which the present invention is applied. The dual mode terminal 200 includes terminal equipment (TE) and a mobile terminal (MT) 270. In the current embodiment of the present invention, the TE corresponds to a conventional multimedia terminal such as a notebook computer or a packet data assistant (PDA).

The dual mode terminal 200 includes a 3GE user interface (UI) 210 and a WLAN UI 220. Operations of setting parameters and processing a menu for 3GE call processing are performed through the 3GE UI 210, and operations of configuring connection with a WLAN access point and processing a menu are carried out through the WLAN UI 220.

The TE 200 further includes a WLAN interface 260 which can use a network interface card (NIC) built in a notebook computer or a PCMCIA type NIC. The MT 270 performs network interface with the TE 200 through a 3GE access module, for example, an RF interface 280.

The TE 200 further includes an L2 module 250 having handover detection and network selection algorithms, an MIPv6 module 230 providing IP mobility, an FMIPv6 unit 240 providing fast lossless handover, and an IPv6 module for IPv6 communication.

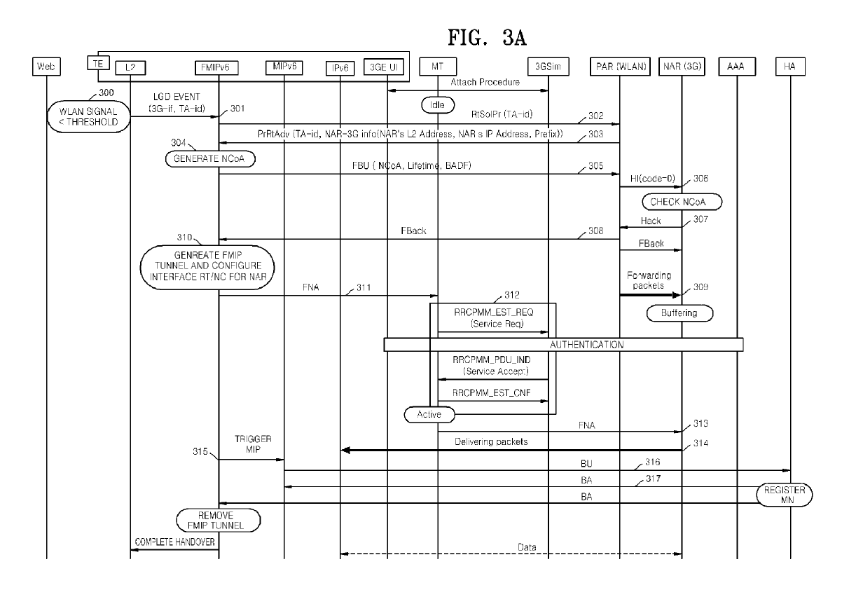

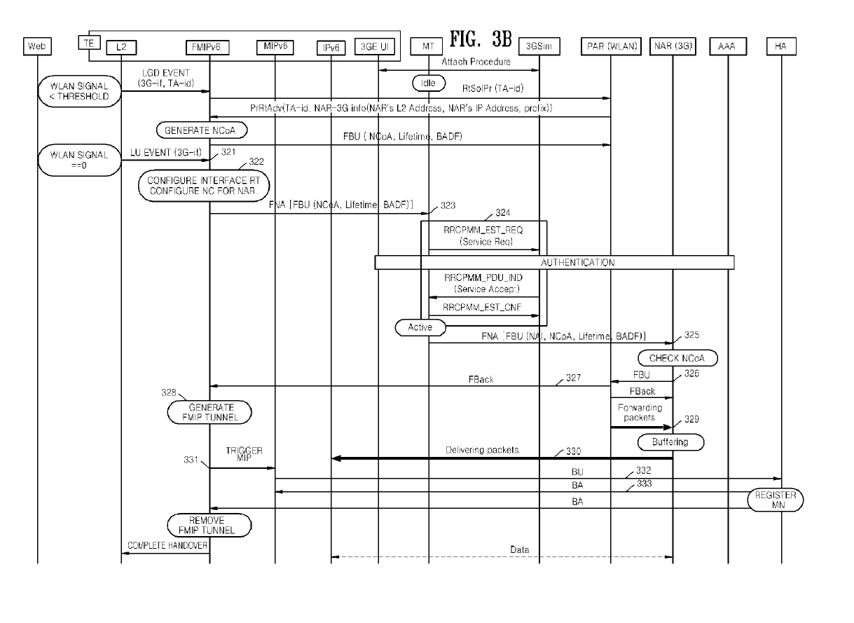

FIG. 3A illustrates a predictive mode process of FMIPv6 in a process for handover from a WLAN to a 3GE network. FIG. 3A illustrates that handover from the WLAN to the 3GE network is performed while a terminal is being provided with a service in the WLAN. A network change event that represents that a radio LAN signal may disappear or be captured, for example, a link going down event, is generated based on the intensity of a received WLAN signal. Specifically, when the intensity of the received WLAN signal is lower than a predetermined threshold value (S300), the link going down event is generated to indicate that the terminal is about to move to the 3GE network from the WLAN service area in operation S301.

In the current embodiment of the present invention, the L2 module 250 illustrated in FIG. 2 generates the link going down event according to a network selection algorithm if the intensity of the received WLAN signal is lower than the predetermined threshold value when the terminal moves from the WLAN to the 3GE network.

In an overlay network structure, connection with the 3GE network is available all the time, and it is required to maintain connection with the WLAN as long as service continuity can be secured without deteriorating service quality. Accordingly, it is preferable that the threshold value corresponding to the basis of determination of link going down satisfies a signal intensity condition that can maintain connection without deteriorating service quality and perform a fast handover operation before a terminal moves.

The link going down event is required to include information on a network access point to which the terminal will be connected after moved in order to perform fast handover based on FMIPv6. Accordingly, when the terminal moves from the WLAN to the 3GE network, the L2 module of the terminal is required to provide information on a 3GE network access point to which the terminal will be connected after moved to the FMIPv6 unit.

The terminal receives information on a new access router (NAR) which will be used after handover from a previous access router (PAR) using a network identifier and prepares for handover when the network change event is generated.

In the current embodiment of the present invention, a tracking area code (TAC) of 3 octets from among tracking area identification (TA-ID) is used as the network identifier used for handover from the WLAN to the 3GE network.

The FMIPv6 unit that receives the link going down event moves to a present access router on the WLAN, PAR-WLAN, and then transmits a router solicitation for proxy advertisement (RtSolPr) message in order to obtain information on a new access router on the 3GE network, NAR-3GE, to which the terminal will be in operation 302.

The network identifier TAC is used for a new access point link-layer address option in the RtSolPr message. The PAR-WLAN that receives the RtSolPr message searches an IP address, an L2 address and subnet prefix information of a new access router on a 3G, NAR-3G, to which the terminal will be connected after handover based on the TAC information extracted from the RtSolPr message and transmits a proxy router advertisement (PrRtAdv) message including the searched information to the terminal in operation 303.

The terminal generates a new care of address (NCoA) to be used after handover based on the subnet prefix information of the NAR-3G acquired through the PrRtAdv message in operation 304 and transmits a fast binding update (FBU) message to the PAR-WLAN for binding a previous care of address (PCoA) and the NCoA in operation 305.

The PAR-WLAN that receives the FBU message from the terminal transmits a handover initiation (HI) message to the NAR-3G in operation 306 and receives a handover acknowledge (Hack) message in response to the HI message in operation 307. Here, the PAR-WLAN validates the NCoA through the Hack message, includes the NCoA in a fast bind acknowledge (FBAck) message and transmits the message to the terminal and the NAR-3G in operation 308.

Furthermore, the PAR-WLAN generates a tunnel between the PCoA and the NCoA and tunnels all packets going toward the PCoA to the NCoA. When the preparatory operation for handover is completed, the NAR buffers all packets transmitted from a destination terminal corresponding to the terminal to the PAR based on NAR information and downloads the buffered data to the terminal when mobile terminal moves to the NAR.

That is, the NAR-3G intercepts packets going toward the NCoA and buffers the intercepted packets in operation 309. The aforementioned operations performed after the network change event is generated use an FMIPv6 protocol and operations after handover, which will be described below, use an MPIPv6 protocol.

The terminal that receives the FBack message generates a tunnel for FMIPv6 and configures interface routing information corresponding to the NCoA and neighbor information for the NAR-3G in operation 310. Accordingly, preparation for handover from the WLAN to the 3GE network is completed, and thus the terminal transmits a fast neighbor advertisement (FNA) message to the NAR-3G to inform the NAR-3G that communication can be carried out in the 3GE network in operation 311.

At this time, the terminal is already in an idle state such that the terminal performs basic connection configuration through an initial connection process and only a radio bearer is cancelled in the 3GE network. The terminal recognizes arrival of an uplink packet according to the FNA message in the idle state and configures the radio bearer for a change from the idle state to an active state. To achieve this, a 3GE signaling process is performed between the MT of the terminal and a 3GE base station and the terminal is changed to the active state in which the terminal can transmit and receive data.

An operation of changing from the idle state to the active state is carried out by recognizing that there is an uplink packet from the MT of the terminal to the 3GE network, transmitting a service request to the 3GE network and receiving a service accept response after configuration of the radio bearer. Here, authentication in the 3GE network is performed if required in operation 312. Then, the FNA message arrives at the NAR-3G in operation 313. Then, the NAR-3G transmits all the buffered packets to the terminal in operation 314. Accordingly, packets using the PCoA during handover are transmitted to the terminal without being lost.

Subsequently, the FMIPv6 unit triggers the MIPv6 module in order to register the terminal with a home agent in operation 315. The MIPv6 module transmits a binding update (BU) message to the home agent in operation 316, confirms that the terminal is registered through a binding acknowledge (BA) message in operation 317 and removes the tunnel for the FMIPv6. Accordingly, the handover process is finished and a normal data transmitting and receiving operation through the NAR-3G is performed in the 3GE network.

FIG. 3B illustrates a reactive mode operation of FMIPv6 in handover from the WLAN to the 3GE network. A reactive mode operates when the terminal that receives the PrTrAdv message does not transmit the FBU message or does not detect a WLAN signal before receiving the FBack message even if the terminal transmits the FBU message, and thus handover is initiated in operation 321. In this case, the terminal does not know whether the FBU message arrives at the PAR-WLAN because the terminal does not receive the FBack message, and thus the terminal configures interface routing information corresponding to the NCoA and neighbor information for NAR-3G in operation 322, encapsulates the FBU message in the FNA message and transmits the FNA message in operation 323. According to the FNA message, a 3GE idle-to-active change of the terminal is performed in operation 324. When the terminal becomes an active state, the FNA message is transmitted to the NAR-3G. The NAR-3G receives the FNA message and confirms whether the NCoA extracted from the FBU message encapsulated in the FNA message is identical to the address used in the corresponding network in operation 325. When the NCoA is not identical to the address, the NAR-3G transmits the FBU message included in the FNA message to the PAR-WLAN in operation 326 and transmits the FBack message to the terminal and the NAR-3G in operation 327. The terminal receives the FBack message and generates an FMIP tunnel in operation 328.

The PAR-WLAN generates a tunnel between the PCoA and the NCoA and tunnels all packets going toward the PCoA to the NCoA in operation 329. Here, the NAR-3G intercepts and buffers packets going to the NCoA and transmits the buffered packets to the terminal in operation 330. The MIPv6 module triggered by the FMIPv6 unit registers the terminal with the home agent in operations 332 and 333. When the registration is completed, the FMIP tunnel is removed and handover is finished.

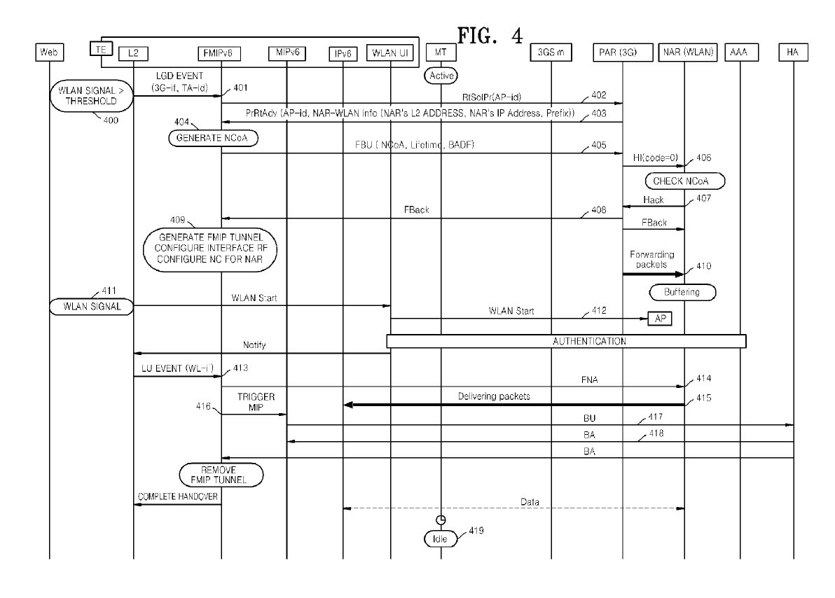

FIG. 4 illustrates a process for handover from a 3GE network to a WLAN. Referring to FIG. 4, an L2 module of a terminal recognizes that the intensity of a WLAN signal increases according to a network selection algorithm while the terminal is in an the active state and generates a link going down event to inform an FMIPv6 unit that an available WLAN exists so that the mobile can move to the WLAN in operation 401.

The network selection algorithm used by the L2 module in the event of handover from the 3GE network to the WLAN generates a link going down event corresponding to a network change event when the intensity of a WLAN signal is higher than a predetermined threshold value in the current embodiment of the present invention.

Connection with the 3GE network can be performed any time in an overlay network structure, and thus a threshold value of WLAN signal intensity capable of performing handover to the WLAN while securing service continuity without deteriorating service quality is used in operation 400.

When the network change event is generated, handover is prepared such that the terminal receives information on a NAR to be used after handover from a PAR to which the terminal is being currently connected using a network identifier. In the event of handover from the WLAN to the 3GE network, the network identifier uses an AP-ID identifying a WLAN.

In case of handover from the 3GE network to the WLAN, the L2 module of the terminal must provide information on a WLAN access point to which the terminal will be connected after handover to the FMIPv6 unit. The FMIPv6 unit that receives the link going down event transmits an RtSolPr message in order to obtain information on a NAR-WLAN to which the terminal will be connected after moved to a PAR-3G in operation 402.

A new access point link-layer address option in the RtSolPr message includes an AP identifier sensing a WLAN signal. The PAR-3G that receives the RtSolPr message searches an IP address, an L2 address and subnet prefix information of the NAR-WLAN to which the terminal will be connected after handover based on the AP information extracted from the RtSolPr message and transmits a PrRtAdv message including the IP address, L2 address and subnet prefix information to the terminal in operation 403.

The terminal generates a NCoA to be used after handover based on the subnet prefix information of the NAR-WLAN, acquired from the PrRtAdv message, in operation 404 and transmits an FBU message to the PAR-3G in order to bind the NCoA and a PCoA in operation 405.

The PAR-3G receives the FBU message from the terminal, transmits an HI message to the NAR-WLAN in operation 406, and receives a Hack message in response to the HI message in operation 407. Here, the PAR-WLAN validates the NCoA through the Hack message and transmits an FBack message including the NCoA to the terminal and the NAR-WLAN. Furthermore, the PAR-3G generates a tunnel between the PCoA and the NCoA and tunnels all packets going toward the PCoA to the NCoA. When the aforementioned handover operation is finished, the NAR-WLAN intercepts packets going to the NCoA and buffers the packets in operation 410.

Furthermore, the terminal receiving the FBack message generates a tunnel for the FMIPv6 and configures interface routing information corresponding to the NCoA and neighbor information for the NAR-WLAN in operation 409. Accordingly, preparation for IP handover from the 3GE network to the WLAN is completed and connection with an access point (AP) is set in operation 412 when the intensity of WLAN signal reaches service available state in operation 411.

Here, an authentication process on the WLAN is performed if required. When the L2 module recognizes completion of connection with the AP, the L2 module informs the FMIPv6 unit of the completion of connection through a link up event in operation 413. The FMIPv6 unit transmits an FNA message to the NAR-WLAN to inform the NAR-WLAN that communication in the WLAN is available in operation 414. When the NAR-WLAN receives the FNA message, the NAR-WLAN transmits all the buffered packets to the terminal in operation 415. Accordingly, packets using the PCoA during handover are transmitted to the terminal without being lost.

Subsequently, the FMIPv6 unit triggers the MIPv6 module in order register the terminal with a HA in operation 416. Then, the MIPv6 module confirms that the terminal is registered using BU/BA messages in operations 417 and 418 and removes the tunnel for FMIPv6. Accordingly, the handover operation is finished and normal data transmission and reception in the WLAN through the NAR-WLAN is performed. The radio bearer used by the terminal in the 3GE network is cancelled after a predetermined time and the terminal is changed to an idle state in operation 419.

The aforementioned process corresponds to the predictive mode process of FMIPv6. In the current embodiment of the present invention, connection with 3GE is available all the time in an overlay structure, and thus connection with the WLAN can be carried out after the FBack message is received. Accordingly, only the predictive mode process can be performed.

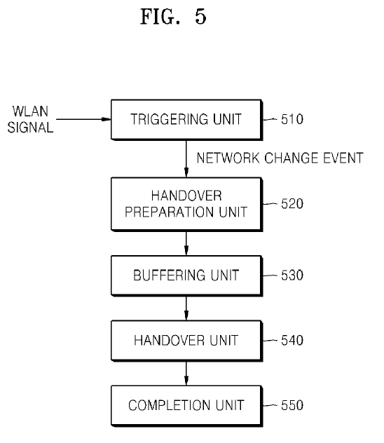

FIG. 5 illustrates a handover operation in a system for supporting fast handover between a 3GE network and a WLAN according to an embodiment of the present invention. Referring to FIG. 5, the system for supporting fast handover between the 3GE network and the WLAN includes a triggering unit 510, a handover preparation unit 520, a buffering unit 530, a handover unit 540 and a completion unit 550.

The triggering unit 510 generates a network change event which represents that a WLAN signal may disappears or be captured on the basis of the intensity of a WLAN signal received by a terminal. The handover preparation unit 520 receives information on a NAR which will be used after handover from a PAR using a network identifier when the network change event is generated. In this case, the network identifier uses a TAC of TA-ID identifying a 3GE network and uses AP-ID identifying a WLAN in the event of handover from the WLAN to the 3GE network.

Upon the completion of preparation for handover, the buffering unit 530 allows the NAR to buffer packets transmitted from a destination terminal corresponding to a terminal to the PAR and download the buffered data to the terminal when the terminal moves to the NAR. When the NAR receives an FNA message from the terminal, the handover unit 540 transmits all the buffered data to the terminal to perform handover without loss.

The completion unit 550 registers the terminal with a home agent of the 3GE network and completes handover in the event of handover from the WLAN to the 3GE network. The completion unit 550 registers the terminal with a home agent of the WLAN and completes handover in the event of handover from the 3GE network to the WLAN.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method for fast handover between different networks, the method comprising:
generating a network change event that represents the state of a WLAN signal based on the intensity of the WLAN signal;
preparing for handover by allowing a terminal to receive information on a second router of a new network to be used after handover from a first router to which the terminal is currently connected using a network identifier when the network change event is generated;
buffering all packets transmitted from a destination terminal corresponding to the terminal to the first router in the second router on the basis of the information on the second router; and
handovering the buffered packets to the terminal when the second router receives a FNA (fast neighbor advertisement) message from the terminal.

2. The method of claim 1, further comprising finishing handover after performing connection with a mobile communication network and registering the terminal with a home agent of the mobile communication network.

3. The method of claim 1, further comprising completing handover after performing connection with a wireless network and registering the terminal with a home agent of the wireless network.

4. The method of claim 1, wherein the network change event is generated, an FMIPv6 protocol is used before the handovering the buffered packets, and an MPIPv6 protocol is used after the handovering the buffered packets.

5. The method of claim 1, wherein the network identifier uses a TAC (tracking area code) from among TA-ID(tracking area identification) identifying a mobile communication network when handover from the mobile communication network to the wireless network is performed.

6. The method of claim 1, wherein the network identifier uses AP-ID (access point identification) identifying a wireless LAN when handover from the wireless network to the mobile communication network is performed.

7. The method of claim 1, wherein the buffering of all packets comprises buffering the packets until handover from the mobile communication to the wireless network or from the wireless network to the mobile communication network is accomplished.

8. The method of claim 1, wherein the preparing for handover comprises:
receiving the information on the second router including an IP address, a L2 (layer 2) address and subnet prefix information of the second router by using the network identifier, wherein the information is received by the first router;
transmitting a proxy router advertisement message including the information on the second router to the terminal; and
generating a NCoA (new care of access) corresponding to a new IP address to be used after handover on the basis of the subnet prefix information, wherein the NCoA is generated by the terminal.

9. The method of claim 8, further comprising:
transmitting a FBU (fast binding update) message for binding a PCoA (previous care of address) currently used by the terminal and the NCoA to the first router;
validating the NCoA between the first router and the second router;
transmitting a FBack (fast bind acknowledge) message including the validated NCoA to the terminal and the second router; and
generating a tunnel for FMIPv6 at the mobile terminal in which the FBack message has been received, and configuring interface routing information corresponding to the NCoA and neighbor information for the second router.

10. The method of claim 9, when the terminal does not receive the FBack message while being connected to the first router, further comprising:
sending the FNA message to the second router, wherein the FBU message is encapsulated into the FNA message in the mobile terminal and;
checking whether the address of NCoA extracted from the FUB message is unique and sending the FBU to the first router when the address of NCoA proves to be unique, wherein the checking is accomplished in the second router transmitting the FBack message including the validated NCoA to the terminal and the second router when the first router has received the FUB message; and
generating the tunnel for FMIPv6 at the mobile terminal, wherein the FBack message is received in the mobile terminal.

11. The method of claim 1, further comprising:
configuring connection with an access point when the intensity of the WLAN signal corresponds to a service available state after the buffering of all packets and before the handovering the buffered packet in case of handover from the mobile communication network to the wireless network.

12. The method of claim 1, wherein the fast handover is performed in a 3GPP SAE/LTE(system architecture evolution/long term evolution) system.

13. The method of claim 1, wherein the terminal corresponds to a dual-mode terminal having a 3GE interface module and a WLAN interface module.

14. The method of claim 1, wherein the mobile communication network and the wireless network have an overlay network structure, wherein a terminal is a connection state all the time in the mobile communication network.

15. The method of claim 1, wherein the network change event is generated in a L2.

16. A system comprising:
a triggering unit generating a network change event that represents the state of a WLAN signal received by a terminal based on the intensity of the WLAN signal;
a handover preparation unit allowing the terminal to receive information on a second router of a new network to be used after handover from a first router to which the terminal is currently connected using a network identifier when the network change event is generated;
a buffering unit buffering all packets transmitted from a destination terminal corresponding to the terminal to the first router in the second router on the basis of the information on the second router; and
a handover unit transmitting the buffered packets to the terminal when the second router receives an FNA message from the terminal.
